(19) United States
(12) Patent Application Publication
(10) Pub. No.: US 2026/0200221 A1
(43) Pub. Date: Jul. 16, 2026

(54) METHOD AND APPARATUS FOR TRANSFERRING ONE OR MORE LAYERS OF A MATERIAL FROM AN INITIAL SUBSTRATE TO A TARGET SUBSTRATE

(71) Applicant: Black Semiconductor Netherlands B.V., Zoetermeer (NL)

(72) Inventors: Richard van Rijn, Zoetermeer (NL); Matthew David Barnes, Zoetermeer (NL); Michele Buscema, Zoetermeer (NL); Dominique Joseph Wehenkel, Zoetermeer (NL)

(73) Assignee: Black Semiconductor Netherlands B.V., Zoetermeer (NL)

(21) Appl. No.: 19/135,096

(22) PCT Filed: Dec. 20, 2023
(86) PCT No.: PCT/NL2023/050671

§ 371 Date: Jun. 3, 2025

(30) Foreign Application Priority Data
Dec. 21, 2022 (NL) 2033775

(51) Int. Cl. B32B 37/00; B32B 9/00; B32B 9/04; B32B 17/10; B32B 27/30; B32B 41/00

(52) U.S. Cl. CPC B32B 37/025; B32B 9/005; B32B 9/007; B32B 9/045; B32B 17/10; B32B 27/308; B32B 41/00; B32B 2313/00; B32B 2313/04; B32B 2315/02; B32B 2315/08; B32B 2333/12

(57) ABSTRACT

The invention relates to a method and an apparatus for transferring a layer of a material from an initial substrate to a target substrate. The apparatus comprises a container for holding an electrolyte solution, a substrate holding member arranged inside the container, a voltage source connectable to the layer of the material and/or to the initial substrate, an actuator for moving the target substrate away from the initial substrate, or vice versa, and a controller for controlling the actuator. The method comprises the steps of:
moving an edge of the target/initial substrate away from the initial/target substrate for providing a separation space between the initial substrate and the layer of the material, with a separation front where the initial substrate and the layer of the material commence separation from each other; and
when the initial substrate with the layer of the material and the target substrate are at least partially submerged in the electrolyte solution and a potential is applied to the layer of the material and/or a surface of the initial substrate that is facing the layer of the material, increasing the separation space and moving the separation front along the initial substrate, wherein the electrolyte diffuses between the initial substrate and the layer of material, wherein the actuator is controlled to provide a progress of the separation front that is equal to or smaller than a diffusion velocity of the electrolyte.

### BACKGROUND

The invention relates to a method and an apparatus for transferring one or more layers of a material from an initial substrate to a target substrate. In particular, wherein the one or more layers of a material comprises one or more single layer of atoms, such as a single layer graphene or a multilayer graphene.

Such a method and apparatus is for example described in EP 2 928 700 B1. This patent publication describes a method of transferring graphene from a metal substrate on which it is formed to a second substrate. First, the second substrate is attached to the graphene. Then, the stack of the metal substrate on which the graphene is formed, the graphene and the second substrate, is immersed in a solution. Subsequently, a mechanical pulling action is used to separate the graphene and second substrate from the original metal substrate with the aid of bubbles, formed electrolytically at the interface between the graphene and the metal, to push the two layers apart.

### SUMMARY OF THE INVENTION

A disadvantage of the known method and apparatus is, that the mechanical pulling action and/or the electrolytically formed bubbles may damage the one or more graphene layers.

It is an object of the present invention to provide a modified and/or alternative method and apparatus for transferring one or more layers of a material, such as graphene, from an initial substrate to a target substrate. In particular, the method at least substantially reduces, and preferably avoids, the occurrence of damage or loss of a part of the one or more layers of the material during the transfer.

According to a first aspect, the present invention pertains to a method for transferring one or more layers of a material from an initial substrate to a target substrate, wherein the method comprises the steps of:
providing the initial substrate with the one or more layers of the material, wherein the initial substrate contacts and supports the one or more layers of the material which defines a first interface between the initial substrate and the one or more layers of the material;
providing a target substrate, and adhering the target substrate to a surface of the one or more layers of the material that is opposite to the first interface; at least partially submerging the initial substrate with the one or more layers of the material and the target substrate in an electrolyte solution;
applying a potential to a surface of the initial substrate that is facing the first interface and/or to the one or more layers of the material; and
moving an edge of the target substrate away from the initial substrate or moving an edge of the initial substrate away from the target substrate, for providing a separation space between the initial substrate and the one or more layers of a material before or during the step of applying the potential, wherein a separation front is provided where the initial substrate and the one or more layers of a material commence to separate from each other; and
increasing the separation space and moving the separation front along the initial substrate by using an actuator for applying a separation force to the target substrate in a direction away from the initial substrate or for applying a separation force to the initial substrate in a direction away from the target substrate, wherein the electrolyte diffuses between the initial substrate and the one or more layers of a material with a diffusion velocity, wherein the actuator is controlled to provide a progress of the separation front that is equal to or smaller than the diffusion velocity of the electrolyte.

The method of the invention allows to delaminate the one or more layers of the material from the initial substrate in a controlled way, by applying an cation/anion induced delamination with a controlled separation of the target substrate and the initial substrate. On the one hand, the step of controlling the actuator to provide a progress of the separation front that is equal to or smaller than the diffusion velocity of the electrolyte, ensures that in the method of the invention, the diffusion of the electrolyte, or in other words the diffusion of the cations and/or anions of the electrolyte, and a resulting cation/anion induced delamination is leading in the transfer of the one or more layers of a material from an initial substrate to a target substrate. Consequently, the amount of force needed to separate the target substrate with the one or more layers of material from the initial substrate is very low, which at least substantially reduces, and preferably avoids, the occurrence of damage or loss of a part of the one or more layers of the material during the transfer.

As mentioned above, the actuator is controlled to provide a progress of the separation front that is equal to or smaller than the diffusion velocity of the electrolyte. Herein, the diffusion velocity may be indirectly measured, e.g. through observing the extent of the separation of the interface between the initial substrate and the one or more layers without applying a pulling force. The method involves ensuring that the separation force applied by the actuator is applied is such a way that the separation front does not extend further into the interface between the initial substrate and the one or more layers. Hence, the diffusion velocity of the electrolyte may be indirectly measured or determined by observation of the extent of the separation of the interfaces. For example, it may be measured/determined optically, e.g. through a camera positioned above a container holding the electrolyte and the substrates. The extent of the separation and thus indirectly the diffusion can be observed through the camera as a line or contour. The force applied to separate the target substrate with the one or more layers from the initial substrate can then be controlled such that the separation front does not extend beyond the expected position of the line or contour indicating the extent of diffusion into the interface between the layers of material and the initial target.

According to the method, should the diffusion be observed as not proceeding and/or partly slowing down or stopping at some point, the application of the separation force can be put on hold, to allow the diffusion to proceed. As the diffusion and thus the interfacial separation again proceeds, the separation force can be applied again. In some embodiments, this could be implemented through a feedback loop.

The observation of the diffusion velocity, also referred to as velocity of diffusion, and the separation front, and the relation there between, is described further in detail in further below in the summary section as well as in the detailed description.

It is noted that the actuator comprises a controllable actuator which is controllable by a controller, such as a computer or a PLC, for performing a desired movement with respect to a substrate holding member for holding the initial substrate or the target substrate. The actuator may comprise a mechanical device, such as a robot, which uses electrical motors, pneumatic or hydraulic cylinders for providing the desired movement. Alternatively, the actuator may comprise a floating body which floats at the surface of the electrolyte and which is connectable to the target substrate, and a liquid level control system for controlling electrolyte level in the container. Such a liquid level control system may comprise a controllable valve connected to a drain for draining a container for holding the electrolyte solution for at least partially submerging the initial substrate with the one or more layers of the material and the target substrate, and lowering the liquid level in the container, and a pumping unit for pumping electrolyte from a storage cannister into the container for raising the liquid level in the container.

It is noted that the method is preferably used for transferring one or more layers of a material from an initial substrate to a target substrate, where the initial substrate is more rigid than the target substate, or vice versa. Accordingly, the method preferably comprises the step of moving an edge of the less rigid one of the initial substrate and the target substrate away from the more rigid one of the initial substrate and the target substrate.

In an embodiment, the potential applied to the surface of the initial substrate that is facing the first interface is set at a voltage such that cations and/or anions of the electrolyte intercalate between the one or more layers of the material and surface of the initial substrate that is facing the first interface and cause a separation of the one or more layers of the material from the initial substrate where the cations and anions of the electrolyte intercalated. An advantage of using only a potential is that all electrochemically driven reactions are blocked, including gas formation at the first interface.

In an embodiment, a counter electrode is at least partially submerged in the electrolyte, and wherein the step of applying a potential comprises the step of establishing a potential difference between the counter electrode and a surface of the initial substrate that is facing the first interface and/or between the counter electrode and the one or more layers of the material. Preferably, the potential difference is set such that substantially no gas bubbles at the first interface and/or at the one or more layers of the material. The absence of gas bubbles further reduces, and preferably avoids, the occurrence of damage or loss of a part of the one or more layers of the material during the transfer.

In an embodiment, the method further comprises the step of detecting an extension of the diffusion of the electrolyte between the one or more layers of the material and the initial substrate, and controlling the actuator to provide a movement of the separation front such that the separation front does not overtake the detected extension of the diffusion. In an embodiment, the extension of the diffusion is detected by using an optical sensor, preferably a light detector or a camera, and wherein the actuator is controlled to provide a progress of the separation front in such a manner that the visible extension of the diffusion is not overtaken by the separation front. For some materials, for example for graphene, the extension of the diffusion of the electrolyte between the one or more layers of the material and the initial substrate is visible by a change in color or contrast, which allows to detect the extension of the diffusion by using an optical sensor, for example a light detector or a camera, and to control the actuator to provide a progress of the separation front in such a manner that the visible extension of the diffusion is not overtaken by the separation front.

It is noted that the optical sensor is particularly suitable in combination with a substantially optical transparent initial substrate and/or a substantially optical transparent target substrate. It is noted that the optical transparency does not necessarily need to be in the visible wavelength range, but may also be in the near-infrared or infrared wavelength range.

In addition or alternatively, in an embodiment, a measured electrical current to the initial substrate and/or to the one or more layers of the material, for establishing and/or maintaining the potential or potential difference is used as a measure for the extension of the diffusion of the electrolyte between the one or more layers of the material and the initial substrate and/or as a measure for a surface area of the one or more layers of the material that has been separated from the initial substrate. It should be noted that the measured electrical current is also dependent on the geometry of the initial substrate and one has to take account of the geometry of the initial substrate to establish a measure for the extension of the diffusion. For example, when the first interface is substantially circular in shape, the length of the separation front changes when moving the separation front along the initial substrate, which yields a non-linear relation between the measured electrical current and the extension of the diffusion.

In an embodiment, the actuator is connected to the target substrate and is configured for pulling the edge of the target substrate away from the initial substrate, for moving an edge of the target substrate away from the initial substrate and/or for increasing the separation space and moving the separation front along the initial substrate. Alternatively, in an embodiment, the actuator is connected to the initial substrate and is configured for pulling the edge of the initial substrate away from the target substrate, for moving an edge of the initial substrate away from the target substrate and/or for increasing the separation space and moving the separation front along the initial substrate. An advantage of this embodiment is that the actuator can be arranged above the target substrate and in particular at least partially above and outside of a container for holding the electrolyte solution, and thus outside the electrolyte solution.

In an embodiment, a force sensor is arranged between the actuator and the target substrate, wherein the method further comprises the step of using the force sensor for measuring a separation force when pulling the edge of the target substrate away from the initial substrate, and controlling the actuator to slow down the pulling of the edge of the target substrate when the measured separation force exceeds a threshold value. Alternatively, in an embodiment, a force sensor is arranged between the actuator and the initial substrate, wherein the method further comprises the step of using the force sensor for measuring a separation force when pulling the edge of the initial substrate away from the target substrate, and controlling the actuator to slow down the pulling of the edge of the initial substrate when the measured separation force exceeds a threshold value. When the separation force exceeds the threshold value, this is an indication that the separation front has overtaken the extension of the diffusion of the electrolyte or is near the extension of the diffusion of the electrolyte. In an embodiment, the threshold value of the measured separation force in Newton (N) is 0.1 times a maximum length of the separation front in meters (m) or below, preferably 0.05 times the maximum length of the separation front or below, more preferably 0.01 times the maximum length of the separation front or below. For example, for a substantially circular initial substrate with a diameter of 100 mm, such as a wafer, the maximum length of the separation front is 100 mm. Accordingly, the threshold value is 0.1 times 100 mm=10 milli-Newton (mN) or below, preferably 0.05 times 100 mm=5 mN or below, more preferably 0.01 times 100 mm=1 mN or below.

It is noted that the measured separation force may, among other things, depend on the bending rigidity of the substrate that is being pulled off. In case the substrate that is being pulled off has a substantial bending rigidity, an additional bending force is required for bending the substrate that is being pulled off away from the other substrate. Accordingly, the force sensor will measure a combination of at least the separation force and the bending force, and preferably the part of the measured force due to the bending force is, at least partially, subtracted from the force as measured by the force sensor to obtain a value for the measured separation force. Alternatively, the maximum bending force for a specific substrate that is being pulled off is added to the threshold value for the measured separation force, in order to obtain a threshold value for the combined separation and bending force. This maximum bending force can be established experimentally before using this specific substrate in the method and apparatus of the present invention.

In addition or alternatively, when the diffusion of the electrolyte between the one or more layer of a specific material and a specific type of initial substrate is known or has been established by experiments, an embodiment of the method further comprises the step of setting and/or timing the control of the actuator based on the known diffusion to provide a progress of the separation front equal to or smaller than the known diffusion velocity of the electrolyte. For example, the velocity of diffusion of the electrolyte can be established by using an optical sensor, preferably a light detector or a camera, to detect the extension of the diffusion and to monitor it as a function of time. Also using a force sensor may be used to establish a measure for the velocity of diffusion of the electrolyte. This embodiment provides the possibility to control an apparatus or method for transferring one or more layers of a material from an initial substrate to a target substrate in a simple way by moving the target substrate at a velocity equal or lower than a known diffusion velocity of the electrolyte, substantially without complex detection and feedback procedures.

An alternative embodiment for performing the step(s) of moving an edge of the target substrate away from the initial substrate and/or increasing the separation space and moving the separation front along the initial substrate, further comprises a step of inserting a wedge in a direction substantially parallel to the first interface for pushing the target substrate away from the initial substrate.

The method and apparatus of the present invention are particularly suitable, but not limited to, for using initial substrates which comprise a substantially rigid substrate, preferably a flat substantially rigid substrate, and wherein the surface of the initial substrate that is facing the first interface is provided with a growth catalyst layer. In an embodiment, the substantially rigid substrate comprises a silicon wafer or a sapphire plate, and/or wherein the growth catalyst layer comprises a metal layer, preferably wherein the metal layer comprising Cu and/or Ni. Using substantially rigid and preferably highly flat rigid substrates are highly advantageous for growing high quality layers of graphene or hexagonal boron nitride, for example, because the rigid substrates provide a stable support for these very thin layers of material which may even comprise a single atom thick layer, at least during the growing of them.

In an embodiment, the one or more layers of material are and/or the metal layer is connected to a voltage source for applying a potential to the one or more layers of material and/or the metal layer, or for establishing a potential difference between the counter electrode and the one or more layers of material and/or the metal layer. Accordingly, the one or more layers of material and/or the metal layer are used to drive or assist the cation/anion induced delamination in the electrolyte in combination with the moving of the target substrate as described above. To provide an electrical connection to the one or more layers of material and/or the metal layer, in an embodiment, the target substrate is provided with a cutout or wherein the target substrate is smaller than the initial substrate for providing an area for electrically connecting the metal layer and/or the one or more layers of the material to the voltage source.

In an embodiment, the target substrate is less rigid than the initial substrate, preferably wherein the target substrate comprises a thermal release sheet, a thinned silicon wafer, a sheet of glass, preferably borosilicate glass, and/or a sheet of plastic, preferably a sheet of Plexiglas, polycarbonate, polyimide, etc. Preferably, the target substrate is also rigid to provide a suitable carrier for the high quality layers of graphene or hexagonal boron nitride, for example, but less rigid than the initial substrate to allow to bend the target substrate for moving the edge of the target substrate away from a substantially unbendable initial substrate. On the one hand, when using a more stiff target substrate, a bending radius of the target substrate will be relatively large, which reduces a critical strain on the one or more layers of the material. On the other hand, a large bending radius will result in a separation space with a small opening angle, which might impede the diffusion of the electrolyte to reach the separation front. Accordingly, a smaller bending radius and a larger opening angle might be advantageous for the diffusion of the electrolyte to reach the separation front.

In an embodiment, the method further comprises the step of positioning a cylindrical roller on top of the target substrate, wherein the cylindrical roller is arranged substantially above the separation front and/or the separations space, and is preferably configured to move along with the moving separation front. The cylindrical roller allows to control and regulate to moving of the target substrate so that the moving has the desired and constant velocity such that the cation/anion induced delamination does have enough time to do its work and to prevent variations in the moving of the edge of the target substrate. In addition, the diameter of the cylindrical roller can also be used to define the bending radius of the target substrate, that is the bending radius is equal or larger than the radius of the cylindrical roller.

The present method and apparatus of the invention are highly suitable for transferring one or more layers of a material from an initial substrate to a target substrate, wherein the one or more layer of materials preferably comprises a layer of an atom thick material, such as graphene or a layer of hexagonal boron nitride (h-BN).

According to a second aspect, the present invention pertains to an apparatus for transferring one or more layers of a material from an initial substrate to a target substrate, wherein the apparatus comprises
a container for holding an electrolyte solution and for at least partially submerging the initial substrate with the one or more layers of the material and the target substrate in the electrolyte solution,
a substrate holding member arranged inside the container, wherein the substrate holding member is configured for retaining the initial substrate,
a voltage source connectable to the one or more layer of the material and/or to the initial substrate,
an actuator configured for applying a separation force to the target substrate in a direction away from the initial substrate, and
a controller for controlling the actuator for:
moving an edge of the target substrate away from the initial substrate or moving an edge of the initial substrate away from the target substrate, for providing a separation space between the initial substrate and the one or more layers of the material, wherein a separation front is provided where the initial substrate and the one or more layers of the material commence separation from each other; and
increasing the separation space and moving the separation front along the initial substrate, wherein the initial substrate with the one or more layers of the material and the target substrate are at least partially submerged in the electrolyte solution and a potential is applied to a surface of the initial substrate that is facing the one or more layers of the material and/or to the one or more layers of the material, wherein the electrolyte diffuses between the initial substrate and the one or more layers of material, wherein the actuator is controlled to provide a progress of the separation front that is equal to or smaller than a diffusion velocity of the electrolyte.

In an embodiment, the actuator is connectable to the target substrate and is configured for pulling the edge of the target substrate away from the initial substrate, wherein the apparatus preferably comprises a force sensor which is connected to the actuator and connectable to the target substrate. In an alternative embodiment, the actuator is connectable to the initial substrate and is configured for pulling the edge of the initial substrate away from the target substrate, wherein the apparatus preferably comprise a force sensor which is connected to the actuator and connectable to the initial substrate.

In an embodiment, the container and/or the substrate holding member is movable in a direction with a component parallel to a first interface between the initial substrate and the one or more layers of the material, preferably wherein the actuator is configured for pulling the edge of the target substrate or the edge of the initial substrate in a direction with a component perpendicular to the first interface. This embodiment allows to control the velocity of the container and/or the substrate holding member in the direction parallel to the first interface to be equal to the velocity of the pulling of the edge of the target substrate in a direction perpendicular to the first interface, which results in that the relative position of the separation front with respect to the position of the actuator stays substantially on the same spot.

In an embodiment, the actuator comprises a wedge which is configured for inserting in between the initial substrate and the target substrate, preferably in a direction substantially parallel to an interface between the initial substrate and the target substrate, for pushing the target substrate with the one or more layers of the material away from the initial substrate.

In an embodiment, the apparatus further comprises an optical sensor, preferably a light detector or a camera, configured for detecting a diffusion of the electrolyte between the one or more layers of the material and the initial substrate, and wherein the optical sensor is connected to the controller for providing a measure of the diffusion of the electrolyte with respect to the separation front.

In an embodiment, the apparatus further comprises a cylindrical roller which is arranged above the substrate holding member, wherein the cylindrical roller is configured to abut on top of the target substrate, and to move along a surface of the target substrate that faces away from the initial substrate.

According to a third aspect, the present invention pertains to an apparatus for transferring one or more layers of a material from an initial substrate to a target substrate, wherein the apparatus comprises
a container for holding an electrolyte solution and for at least partially submerging the initial substrate with the one or more layers of the material and the target substrate in the electrolyte solution,
a substrate holding member arranged inside the container, wherein the substrate holding member is configured for retaining the initial substrate,
a voltage source connectable to the one or more layers of the material and/or to the initial substrate,
an actuator configured for applying a separation force to the target substrate in a direction away from the initial substrate or to the initial substrate in a direction away from the target substrate,
wherein the actuator is connectable to the target substrate or initial substrate and is configured for pulling the edge of the target substrate or initial substrate away from the initial substrate or target substrate, wherein the apparatus comprises a force sensor which is connected to the actuator and connectable to the target substrate or initial substrate, and
a controller configured for using a signal from the force sensor for controlling the actuator.

According to a fourth aspect, the present invention pertains to an apparatus for transferring one or more layers of a material from an initial substrate to a target substrate, wherein the apparatus comprises
a container for holding an electrolyte solution and for at least partially submerging the initial substrate with the one or more layers of the material and the target substrate in the electrolyte solution,
a substrate holding member arranged inside the container, wherein the substrate holding member is configured for retaining the initial substrate,
a voltage source connectable to the one or more layers of the material and/or to the initial substrate,
an actuator, wherein the actuator is configured for applying a separation force to the target substrate in a direction away from the initial substrate or to the initial substrate in a directions away from the target substrate,
wherein the actuator is connectable to the target substrate or the initial substrate and is configured for pulling the edge of the target substrate or the initial substrate away from the initial substrate or the target substrate, wherein the container and/or the substrate holding member is movable in a direction with a component parallel to a first interface between the initial substrate and the one or more layers of the material, and wherein the actuator is configured for pulling the edge of the target substrate or the initial substrate in a direction with a component perpendicular to the first interface, and
a synchronizing means or a synchronizing member for synchronizing a movement of the container and/or substrate holding member along a direction parallel to the first interface with a movement of the actuator along a direction perpendicular to the first interface.

According to a fifth aspect, the present invention pertains to an apparatus for transferring one or more layers of a material from an initial substrate to a target substrate, wherein the apparatus comprises
a container for holding an electrolyte solution and for at least partially submerging the initial substrate with the one or more layers of the material and the target substrate in the electrolyte solution,
a substrate holding member arranged inside the container, wherein the substrate holding member is configured for retaining the initial substrate,
a voltage source connectable to the one or more layers of the material and/or to the initial substrate,
an actuator configured for applying a separation force to the target substrate in a direction away from the initial substrate or to the initial substrate in a direction away from the target substrate,
an optical sensor, preferably a light detector or a camera, configured for detecting a diffusion of the electrolyte between the one or more layers of the material and the initial substrate, wherein the optical sensor is connected to a controller for providing a measure of the diffusion of the electrolyte with respect to a separation front where the initial substrate and the one or more layers of the material commence separation from each other, wherein the controller is configured for controlling the actuator based on the measure of the diffusion of the electrolyte with respect to the separation front.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 schematically shows a cross-section view of a first example of an apparatus according to the invention;

FIG. 2 schematically shows a cross-section view of a second example of a part of an apparatus according to the invention;

FIG. 3 schematically shows a cross-section view of a third example of an apparatus according to the invention; FIG. 4 schematically shows a cross-section view of a fourth example of an apparatus according to the invention; and

FIG. 5 schematically shows the steps in a method according to the invention.

It is noted that in the enclosed figures, the same features are indicated by the same reference numbers.

### DETAILED DESCRIPTION OF THE INVENTION

In the following, examples of the present invention will be described with reference to the appended figures. Equal or equivalent elements or elements with equal or equivalent functionality may be denoted in the following description and in the figures by equal or equivalent reference numerals.

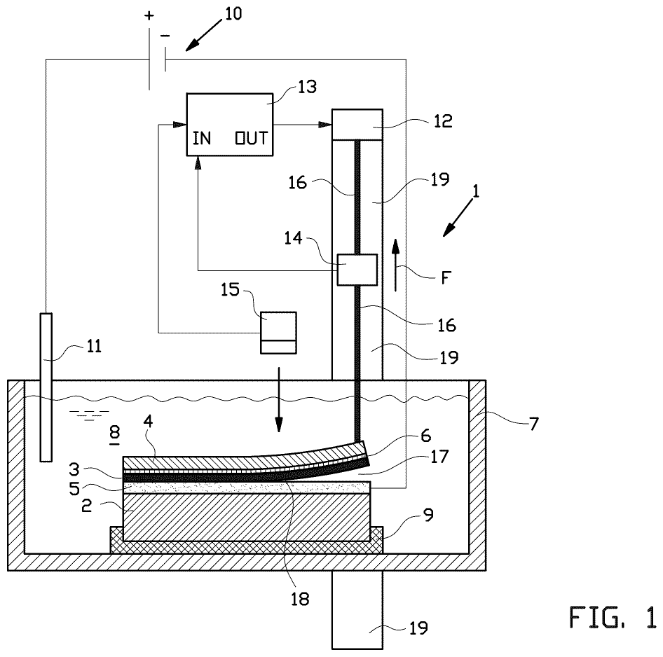

FIG. 1 schematically shows a cross-section view of a first example of an apparatus 1 according to the invention. The apparatus 1 is configured for transferring one or more layers 2 of a material from an initial substrate to a target substrate 4.

The one or more layers 3 of a material such as graphene of h-BN are grown on a flat surface of the initial substrate 2. The present invention preferably uses sapphire disk for the initial substrate 2, because they can be provided with a highly flat surface and are readily available. The surface of initial substrate 2 onto which the one or more layers 3 of the material is to be grown, is provided with a growth catalyst layer 5, which preferably is a metal layer, more preferably a metal layer comprising copper (Cu) or nickel (Ni), or a combination of copper (Cu) and nickel (Ni). Other metals are also possible.

After the one or more layers 3 of the material are provided on top of the growth catalyst layer 5, a thin polymer layer 6 is provided on top of the one or more layers 3 of the material. The thin polymer layer 6 preferably is a spin-coated layer comprising, for example Polymethylmethacrylate (PMMA), Polycarbonate (PC) or Polystyrene (PS), but many more polymers are possible. Preferably a layer of PMMA is used for the thin polymer layer 6, because it can be relatively easy removed from the one or more layers 3 of the material.

Subsequently, a target substrate 4 is arranged on top of the thin polymer layer 6. An example of such a stack comprises: sapphire/metal (preferably Cu and/or Ni)/one or more layers of the material (for example Graphene or h-BN)/PMMA/target substrate. The target substrate 4 may comprise a thermal release tape as known in the art, but preferably comprises a stiff substrate, such as a thin plate of borosilicate glass or a thinned silicon wafer, wherein the target substrate 4 is less rigid as the initial substrate 2. In the apparatus 1 of the present invention, the less rigid target substrate 4 is moved away from the more rigid initial substrate 2.

It is noted, that in some examples an additional adhesive layer is arranged in between the polymer layer 6 and the target substrate 4. An example of such a stack comprises: sapphire/metal (preferably Cu and/or Ni)/one or more layers of the material (for example Graphene or h-BN)/PMMA/adhesive/target substrate. An example of the additional adhesive may be WaferBOND®, HT-10.11 or HT-10.12 from the company BrewerScience, but other adhesives can be used as well.

It is further noted that it is also possible, in an alternative method, to use a target substrate that is more rigid than the initial substrate. In this case, in the apparatus 1 of the present invention, the less rigid initial substrate 2 is moved away from the more rigid target substrate 4. The below examples relate to a combination of a more rigid initial substrate and a less rigid target substrate. However the apparatus and method may also be applied for transferring one or more layers of a material from a less rigid initial substrate to a more rigid target substrate.

As further schematically shown in FIG. 1, the apparatus according to this first example comprises:
a container 7 for holding an electrolyte solution 8 and for at least partially submerging the initial substrate 2 with the one or more layers 3 of the material and the target substrate 4 in the electrolyte solution 8,
a substrate holding member 9 arranged inside the container 7, wherein the substrate holding member 9 is configured for retaining the more rigid one of the initial substrate 2 and the target substrate 4; in this example the initial substrate 2 is retained,
a voltage source 10 connected to a counter electrode 11 arranged inside the container 7,
an actuator 12, wherein the actuator is configured for applying a separation force to the less rigid one of the initial substrate 2 and the target substrate 4 in a direction away from the more rigid one of the initial substrate 2 and the target substrate 4; in this example the separation force is applied to the target substrate 4 in a direction away from the initial substrate 2, and
a controller 13 for controlling the apparatus 1 and in particular the actuator 12.

The actuator 12 is mounted on a frame 19 which is connected to the container 7.

In use, the initial substrate 2 with the one or more layers 3 of the material and the target substrate 4 is submerged in the electrolyte solution 8. The electrolyte solution 8 diffuses at least in between the initial substrate 2 and the one or more layers 3 of the material. A potential difference is established between the counter electrode 11 and a surface of the initial substrate 2 that is facing the one or more layers 3 of the material, in particular between the counter electrode 11 and the growth catalyst layer 5, in order to provide an electrochemical delamination of the one or more layers 3 of the material from the growth catalyst layer 5 of the initial substrate 2. The one or more layers 3 of the material, in particular the graphene, is delaminated using the electrolyte solution 8 with cations and anions that can intercalated between the one or more layers 3 of the material and the growth catalyst layer 5.

In addition, the actuator 12 is connected to the target substrate 4 via a connecting member 16, and is controlled by the controller 13 for lifting an edge of the target substrate 4 away from the initial substrate 2 for providing a separation space 17 between the initial substrate 2 and the one or more layers 3 of the material. A separation front 18 is provided where the initial substrate 2 and the one or more layers 3 of the material start to move apart. In particular, when the target substrate 4 comprises a semi-rigid substrate, such as a thin sheet of borosilicate glass or a thinned Silicon wafer, the actuator 12 pulls on the target substrate 4 so that it slightly bends away from the initial substrate 2 to provide a greater diffusion path for the electrolyte solution 8 to diffuse into the separation space 17.

Accordingly, the present invention utilizes a combination of moving the edge of the target substrate 4 by the actuator and using electrochemical delamination in such a way that the electrochemical delamination is leading and the mechanical stresses and/or forces on the one or more layers 3 of the material by the moving of the target substrate 4 are small. In other words, the actuator 12 is controlled to increase the separation space 17 and move the separation front 18 along the initial substrate 2, such that a progress of the separation front 18 is equal to or smaller than a diffusion velocity of the electrolyte solution 8 in between the initial substrate 2 and the one or more layers 3 of material.

There are several ways to ensure that the diffusion and thereby the electrochemical delamination is leading:

A first option is detecting an extension of the diffusion of the electrolyte solution 8 and/or an intercalation of the cations and anions of the electrolyte solution 8 between the one or more layers 3 of the material and the initial substrate 2, by using an optical sensor 15, preferably a light detector or a camera. For some materials, for example for graphene, and when using a transparent polymer layer 6 and target substrate 4, the extension of the diffusion of the electrolyte solution 8 and/or an intercalation of the cations and anions of the electrolyte solution between the one or more layers 3 of the material and the initial substrate 2 is visible by a change in color or contrast. The optical sensor 15 is connected to the controller 13 for sending data collected by the optical sensor 15 to the controller 13. The controller 13 is connected to the actuator 12 for controlling the actuator 12, based on the data from the optical sensor 15, in such a manner that a progress of the separation front 18 does not approach or overtakes the visible detected extension of the diffusion of the electrolyte solution 8 and/or an intercalation of the cations and anions of the electrolyte solution 8, it can be assured that the diffusion and thereby the electrochemical delamination is leading when transferring the one or more layers 3 of a material from an initial substrate 2 to a target substrate 4.

It is noted that the separation front 18 where the initial substrate 2 and the one or more layers 3 of the material commence separation from each other, may also detectable by the optical sensor 15, which allows to use an optical sensor 15 for detecting both the separation front 18 on the one hand, and the extension of the diffusion of the electrolyte solution 8 and/or an intercalation of the cations and anions of the electrolyte solution 8 on the other hand.

A second option is to arrange a force sensor 14 between the actuator 12 and the target substrate 4. When the diffusion and thereby the electrochemical delamination is leading when transferring the one or more layers 3 of a material from an initial substrate 2 to a target substrate 4, then the force F required for moving the target substrate 4 away from the initial substrate 2 is small. Accordingly, the force sensor 14 can be used for measuring a separation force F when pulling the edge of the target substrate 4 away from the initial substrate 2. The force sensor 14 is connected to the controller 13 for sending data collected by the force sensor 14 to the controller 13. The controller 13 is connected to the actuator 12 for controlling the actuator 12, based on the data from the force sensor 14, in such a manner that the pulling of the edge of the target substrate 4 by the actuator 12 is slowed down when the measured separation force F exceeds a threshold value. When the separation force F exceeds the threshold value, this is an indication that the separation front 18 is near to or has overtaken the extension of the diffusion of the electrolyte solution 8 and/or the intercalation of the cations and anions of the electrolyte solution 8. Experiments have shown that when the diffusion and thereby the electrochemical delamination is leading when transferring a Graphene layer from a silicon wafer (initial substrate 2) with a layer of copper (growth catalyst layer 5) to a thermal release tape (target substrate 4), and using a thin PMMA polymer layer 6, the separation force F is below 10 mN. Accordingly, a value of the separation force F of 10 milli-Newton (mN) or below can be used for the threshold value.

A third solution is setting and/or timing the control of the actuator 12 based on a known diffusion velocity to provide a progress of the separation front 18 equal to or smaller than the known velocity of the diffusion of electrolyte solution 8 and/or of the intercalation of the cations and anions of the electrolyte solution 8 between the one or more layers 3 of the material and the initial substrate 2. This solution is convenient when the velocity of the diffusion of the electrolyte solution 8 and/or the intercalation of the cations and anions of the electrolyte solution 8 between the one or more layers 3 of the material and the initial substrate 2 is known or has been established by experiments. For example, the velocity of diffusion of the electrolyte can be established by using an optical sensor 15, preferably a light detector or a camera, to detect the extension of the diffusion and to monitor it as a function of time. Also using a force sensor 14 may be used to establish a measure for the velocity of diffusion of the electrolyte.

It is noted that when the apparatus and method is used for transferring one or more layers of a material from a less rigid initial substrate to a more rigid target substrate, then the layered structure of the initial substrate 2 with the one or more layers 3 of the material and the target substrate 4 is arranged on the substrate holding member 9 in a upside down position. That is, the more rigid target substrate is attached to and retained by the substrate holding member 9, and the connecting member 16 of the actuator 12 is connected to an edge of the initial substrate.

It is further noted that the actuator 12 comprises a controllable actuator which is controllable by a controller 13, such as a computer or a PLC, for performing a desired movement of the connecting member 16 with respect to the substrate holding member 9. The actuator 12 may comprise a mechanical device, such as a robot, which uses electrical motors, pneumatic or hydraulic cylinders for providing the desired movement.

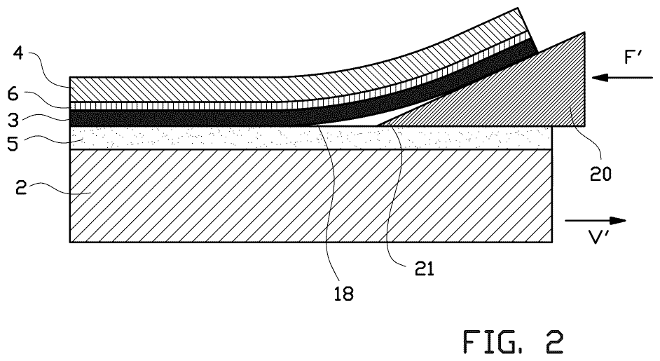

As an alternative for using a connecting member 16 for connecting the actuator 12 to an edge of the less rigid one of the initial substate 2 and target substrate 4, a wedge 20 may be used for moving the edge and/or for increasing the separation space between the initial substrate 1 and the target substrate 3, by inserting the wedge 20 in a direction substantially parallel to the surface of growth catalyst layer 5 for pushing the target substrate 3 with the one or more layers 2 of the material away from the initial substrate 2, as schematically shown in FIG. 2. The apparatus that comprises the wedge 20 can be provided with an actuator connected to the wedge 20 and configured for pushing the wedge 20 with a force F′ in the direction substantially parallel to the surface of growth catalyst layer 5. In addition or alternatively, the apparatus that comprises the wedge 20 can be provided with an actuator connected to the substrate holding member 9 and is configured for moving the substrate holding member 9 back and forth in a direction V′ substantially parallel to the surface of growth catalyst layer 5, wherein the wedge 20 can remain at least in the direction parallel to the surface of the growth catalyst layer 5 at a fixed position during the lifting of the edge and/or the increasing of the separation space.

It is noted that the size of the wedge 20 in FIG. 2 is highly exaggerated to more clearly show the effect of insertion of the wedge 20 between the growth catalyst layer 5 and the one or more layers 3 of the material. In practice the wedge angle is preferably less than 45 degrees. Preferably the wedge comprises a tip 21 with a radius of curvature, wherein the radius of the curvature at the tip of the wedge is preferably smaller than 0.5 times the thickness of the polymer layer and adhesive layer (if present).

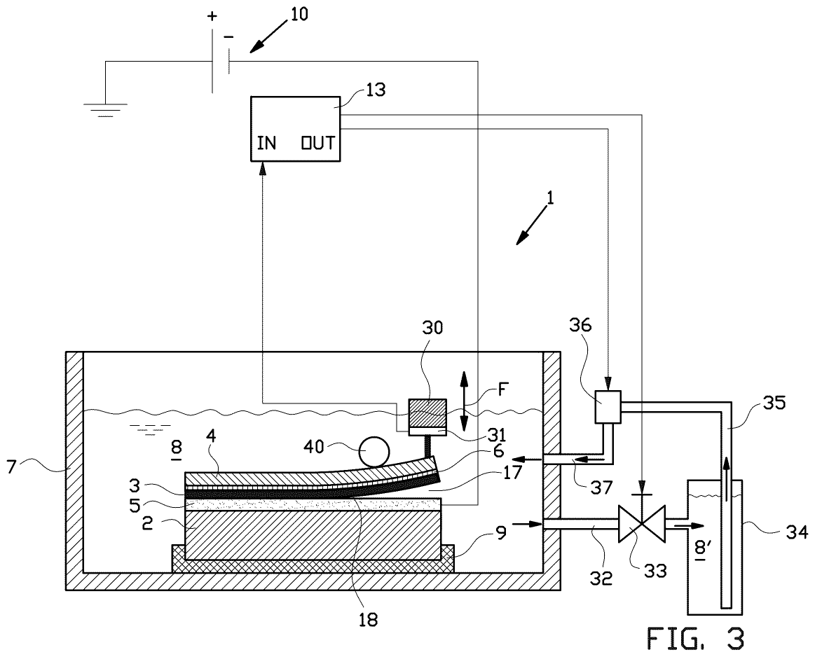

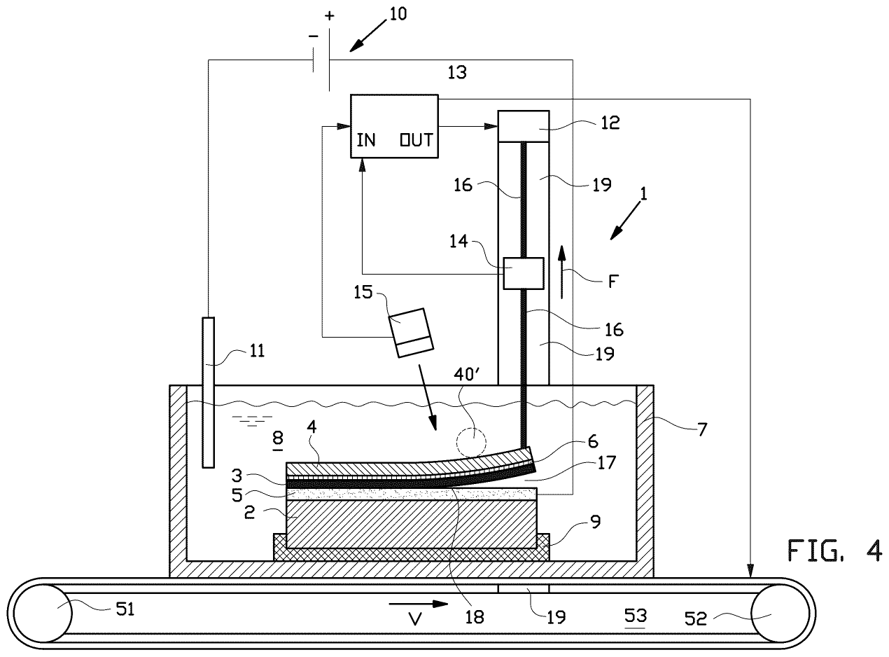

FIG. 3 schematically shows a cross-section view of a third example of an apparatus according to the invention. In this example, the actuator or actuator assembly comprises:
a floating body 30 which floats at the surface of the electrolyte solution 8 and which is connectable to the target substrate 6, and
a liquid level control system for controlling a level of the electrolyte solution 8 in the container 7, wherein the liquid level control system comprise a controllable valve 33 connected to a output port or drain of the container 7 for removing electrolyte solution 8 out of the container 7 and lowering the liquid level in the container 7, and a pumping unit 36 for pumping electrolyte solution 8′ from a storage cannister 34 into the container 7 for raising the liquid level in the container 7.

In this example, the controllable valve 33 is arranged in an output tube 32 which connects the output port or drain of the container 7 with the storage cannister 34. Electrolyte solution 8′ from the storage cannister 34 can be pumped into the container 7 by means of the pumping unit 36 which is arranged in an input tube 35, 37 which connects an input port of the container 7 with the storage cannister 34. Both the controllable valve 33 and the pumping unit 36 are connected to and controllable by the controller 13.

In addition, the floating body 30 may be provided with a force sensor 31 arranged between the floating body 30 and the target substrate 4. The force sensor 31 is connected to the controller 13 for sending data collected by the force sensor 31 to the controller 13. The controller 13 is connected to the controllable valve 33 and the pumping unit 36 for controlling the level of the electrolyte solution 8 in the container 7, based on the data from the force sensor 31, in such a manner that the pulling of the edge of the target substrate 4 by the floating body 31 is slowed down by decreasing a electrolyte level increase, when the measured separation force F exceeds a threshold value.

It is noted that the apparatus of the third example does not comprise a counter electrode. The voltage source 10 is on the one hand connected to earth potential and on the other hand connected to the growth catalyst layer 5 in order to apply a potential to the growth catalyst layer 5 to enable an intercalation of cations/anions of the electrolyte between the one or more layers 3 of the material and the growth catalyst layer 5, resulting in a cation/anion induced delamination of the one or more layers 3 of the material from the growth catalyst layer 5.

It is noted that the example of the apparatus 1 of the invention as shown in FIG. 3 can also work with a counter electrode as discussed above with reference to FIG. 1. It is further noted that the example of the apparatus of the invention as shown in FIG. 1 can also work without the counter electrode 11 as discussed above with reference to FIG. 3.

Furthermore, the apparatus may comprise a cylindrical roller 40, which is arranged above the substrate holding member 9, such that in use, the cylindrical roller 40 is configured to abut against a side of the target substrate 4 which faces away from the initial substrate 2. As schematically shown in FIG. 3, the cylindrical roller 40 is arranged substantially above the separation front 18 and/or the wedge-shaped separations space 17. Preferably the cylindrical roller 40 is configured to move along with the moving separation front 18. The cylindrical roller 40 allows to control and regulate the moving of the target substrate 4 away from the initial substrate 2 so that the moving has the desired and constant velocity such that the electrochemistry does have enough time to do its work and to prevent variations in the separation of the target substrate 4 from the initial substrate 2, or vice versa. In addition or alternatively, the cylindrical roller 40 is configured to control and regulate the curvature of the upwards bending of a semi-rigid target substrate 4. For a flexible target substrate 4, the diameter of the cylindrical roller 40 can be used to define the bending radius of the target substrate 4, that is the bending radius is equal or larger than the radius of the cylindrical roller 40.

It is noted that the example of the apparatus 1 of the invention as shown in FIG. 3 can also work without the cylindrical roller 40, and that such a cylindrical roller 40 can also be applied in the example of the apparatus 1 of the invention as shown in FIG. 1.

FIG. 4 schematically shows a cross-section view of a fourth example of an apparatus 1 according to the invention. The apparatus 1 of this fourth example is substantially the same as in the first example with the addition that the the container 7 and the substrate holding member 9 is movable in a direction V which is substantially parallel to a first interface between the initial substrate 2 and the one or more layers 3 of the material. In this example, the movement of the container 7 and the substrate holding member 9 is provided by a conveyor with rollers 51, 52 rotatably connected to a conveyor frame 53. In addition, the actuator 12 and the optical sensor 15 are not directly connected to the container 7 and are connected to the conveyor frame 53 and are arranged preferably stationary with respect to the conveyor frame 53 and do not move together with the container 7. Accordingly, the apparatus 1 of this fourth example allows to compensate for horizontal deviations of the position where the connecting member 16 is connected to the target substrate 4 due to the upwards bending of the target substrate 4. Any horizontal deviation can be compensated by moving the container 7 and the substrate holding member 9 with the conveyor 51, 52.

Preferably, the apparatus 1 comprises a synchronizing means or synchronizing member for synchronizing a movement of the container 7 and substrate holding member 9 along a direction parallel to the first interface with a movement of the actuator 12 along a direction perpendicular to the first interface. The synchronizing means may be provided by the controller 13, which is then configured to control the velocity of the container 7 and the substrate holding member 9 in the direction V parallel to the first interface to be equal to the velocity of the pulling of the edge of the target substrate 4 in a direction perpendicular to the first interface. Alternatively, the synchronizing member may comprise a mechanical coupling between the actuator 12 and the conveyor 51, 52 such that they move synchronously; when the actuator 12 moves the connecting member 16 upwards, the same actuator 12 moves the conveyor to the right via the mechanical coupling (not shown). Preferably, the synchronizing means are configured such that the relative position of the separation front 18 with respect to the position of the actuator 12 stays substantially on the same spot.

It is noted that the example of the apparatus of the invention as shown in FIG. 4 can also work without the counter electrode 11 as discussed above with reference to FIG. 3.

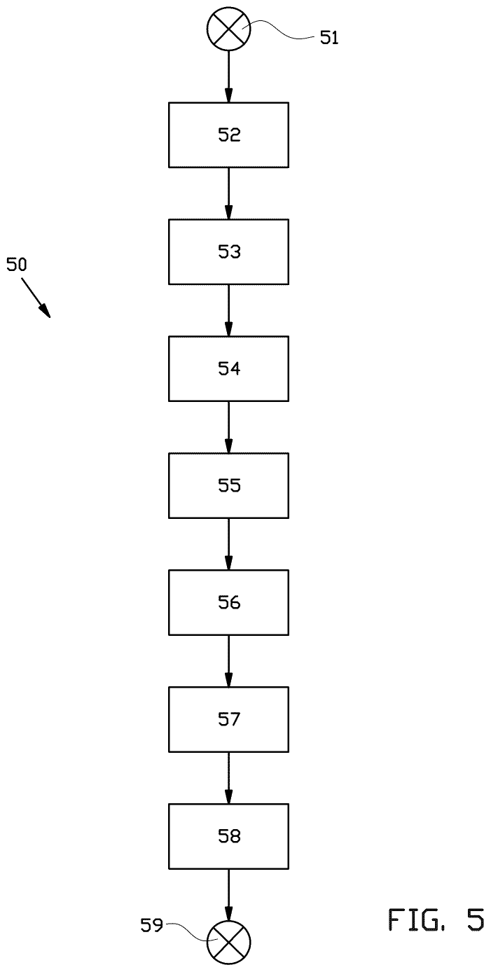

FIG. 5 schematically shows the steps in a method according to the invention. In particular, when the method starts 51, the method comprises the steps of:
52 providing the initial substrate with the one or more layers of the material, wherein the initial substrate contacts and supports the one or more layers of the material which defines a first interface between the initial substrate and the one or more layers of the material;
53 providing a target substrate, and adhering the target substrate to a surface of the one or more layers of the material that is opposite to the first interface;
54 at least partially submerging the initial substrate with the one or more layers of the material and the target substrate in an electrolyte solution which is provided with a counter electrode;
55 establishing a potential difference between the counter electrode and a surface of the initial substrate that is facing the first interface; and
56 moving an edge of the target substrate away from the initial substrate or moving an edge of the initial substrate away from the target substrate, for providing a wedge-shaped separation space between the initial substrate and the one or more layers of a material before or during the step of establishing the potential difference, wherein a separation front is provided where the initial substrate and the one or more layers of a material start to move apart;
57 increasing the separation space and moving the separation front along the initial substrate by using an actuator for applying a separation force to the target substrate in a direction away from the initial substrate or for applying a separation force to the initial substrate in a direction away from the target substrate, wherein the electrolyte diffuses in between the initial substrate and the one or more layers of material, and
58 controlling the actuator to provide a progress of the separation front that is equal to or smaller than a diffusion velocity of the electrolyte, until the complete target substrate with the one or more layers of the material are separated from the initial substrate, and the method ends 59.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

In summary, the invention relates to a method and an apparatus for transferring a layer of a material from an initial substrate to a target substrate. The apparatus comprises a container for holding an electrolyte solution, a substrate holding member arranged inside the container, a voltage source connectable to the layer of the material and/or to the initial substrate, an actuator for moving the target substrate away from the initial substrate, or vice versa, and a controller for controlling the actuator. The method comprises the steps of:
moving an edge of the target/initial substrate away from the initial/target substrate for providing a separation space between the initial substrate and the layer of the material, with a separation front where the initial substrate and the layer of the material commence separation from each other; and
when the initial substrate with the layer of the material and the target substrate are at least partially submerged in the electrolyte solution and a potential is applied to the layer of the material and/or a surface of the initial substrate that is facing the layer of the material, increasing the separation space and moving the separation front along the initial substrate, wherein the electrolyte diffuses between the initial substrate and the layer of material, wherein the actuator is controlled to provide a progress of the separation front that is equal to or smaller than a diffusion velocity of the electrolyte.

1. A method for transferring one or more layers of a material from an initial substrate to a target substrate, wherein the method comprises the steps of:
providing the initial substrate with the one or more layers of the material, wherein the initial substrate contacts and supports the one or more layers of the material which defines a first interface between the initial substrate and the one or more layers of the material;
providing a target substrate, and adhering the target substrate to a surface of the one or more layers of the material that is opposite to the first interface;
at least partially submerging the initial substrate with the one or more layers of the material and the target substrate in an electrolyte solution;
applying a potential to a surface of the initial substrate that is facing the first interface and/or to the one or more layers of the material; and
moving an edge of the target substrate away from the initial substrate or moving an edge of the initial substrate away from the target substrate, for providing a separation space between the initial substrate and the one or more layers of a material before or during the step of applying the potential, wherein a separation front is provided where the initial substrate and the one or more layers of a material commence to separate from each other; and
increasing the separation space and moving the separation front along the initial substrate by using an actuator for applying a separation force to the target substrate in a direction away from the initial substrate or for applying a separation force to the initial substrate in a direction away from the target substrate, wherein the electrolyte diffuses between the initial substrate and the one or more layers of material, wherein the actuator is controlled to provide a progress of the separation front that is equal to or smaller than a diffusion velocity of the electrolyte.

2. The method according to claim 1, wherein the method further comprises the step of detecting an extension of the diffusion of the electrolyte between the one or more layers of the material and the initial substrate, and controlling the actuator to provide a movement of the separation front such that the separation front does not overtake the detected extension of the diffusion.

3. The method according to claim 2, wherein the extension of the diffusion is detected by using an optical sensor, preferably a light detector or a camera, and wherein the actuator is controlled to provide a progress of the separation front in such a manner that the visible extension of the diffusion is not overtaken by the separation front.

4. The method according to claim 1, 2 or 3, wherein the actuator is connected to the target substrate and is configured for pulling the edge of the target substrate away from the initial substrate, for moving an edge of the target substrate away from the initial substrate and/or for increasing the separation space and moving the separation front along the initial substrate, or
wherein the actuator is connected to the initial substrate and is configured for pulling the edge of the initial substrate away from the target substrate, for moving an edge of the initial substrate away from the target substrate and/or for increasing the separation space and moving the separation front along the initial substrate.

5. The method according to claim 4, wherein a force sensor is arranged between the actuator and the target substrate, wherein the method further comprises the step of using the force sensor for measuring a separation force when pulling the edge of the target substrate away from the initial substrate, and controlling the actuator to slow down the pulling of the edge of the target substrate when the measured separation force exceeds a threshold value, or
wherein a force sensor is arranged between the actuator and the initial substrate, wherein the method further comprises the step of using the force sensor for measuring a separation force when pulling the edge of the initial substrate away from the target substrate, and controlling the actuator to slow down the pulling of the edge of the initial substrate when the measured separation force exceeds a threshold value.

6. The method according to claim 5, wherein the threshold value of the measured separation force (in Newton) is 0.10 times a maximum length of the separation front (in meters) or below, preferably 0.05 times the maximum length of the separation front or below, more preferably 0.01 times the maximum length of the separation front or below.

7. The method according to claim 1, wherein the diffusion of the electrolyte between the one or more layer of a specific material and a specific type of initial substrate is known or has been established by experiments or using a method step according to any one of the claims 2-6, and wherein the method further comprises the step of setting and/or timing the control of the actuator based on the know diffusion to provide a progress of the separation front equal to or smaller than the known diffusion velocity of the electrolyte.

8. The method according to any one of the claims 1-7, wherein the step(s) of moving an edge and/or increasing the separation space and moving the separation front along the initial substrate, further comprises a step of inserting a wedge in a direction substantially parallel to the first interface for pushing the target substrate away from the initial substrate.

9. The method according to any one of the claims 1-8, wherein the initial substrate comprises a substantially rigid substrate, preferably a flat substantially rigid substrate, and wherein the surface of the initial substrate that is facing the first interface is provided with a growth catalyst layer.

10. The method according to claim 9, wherein the substantially rigid substrate comprises a silicon wafer or a sapphire plate, and/or wherein the growth catalyst layer comprises a metal layer, preferably wherein the metal layer comprising Cu and/or Ni.

11. The method according to-claim 10, wherein the metal layer is connected to a voltage source to apply a potential to the metal layer, preferably wherein the target substrate is provided with a cutout or wherein the target substrate is smaller than the initial substrate for providing an area for electrically connecting the metal layer to the voltage source.

12. The method according to any one of the claims 1-11, wherein the method further comprises the step of positioning a cylindrical roller on top of the target substrate, wherein the cylindrical roller is arranged substantially above the separation front and/or the separation space and is configured to move along with the moving separation front.

13. The method according to any one of the claims 1-12, wherein the target substrate is less rigid that the initial substrate, preferably wherein the target substrate comprises a thermal release sheet, a thinned silicon wafer, a sheet of glass, preferably borosilicate glass, and/or a sheet of plastic, preferably a sheet of Plexiglas, polycarbonate, polyimide, etc.

14. The method according to any one of the claims 1-13, wherein the one or more layer of materials comprises a layer of graphene or a layer of hexagonal boron nitride (h-BN).

15. An apparatus for transferring one or more layers of a material from an initial substrate to a target substrate, wherein the apparatus comprises
a container for holding an electrolyte solution and for at least partially submerging the initial substrate with the one or more layers of the material and the target substrate in the electrolyte solution,
a substrate holding member arranged inside the container, wherein the substrate holding member is configured for retaining the initial substrate or the target substrate,
a voltage source connectable to the one or more layers of the material and/or to the initial substrate,
an actuator configured for applying a separation force to the target substrate in a direction away from the initial substrate or to the initial substrate in a direction away from the target substrate, and
a controller for controlling the actuator for:
moving an edge of the target substrate away from the initial substrate or moving an edge of the initial substrate away from the target substrate, for providing a separation space between the initial substrate and the one or more layers of the material, wherein a separation front is provided where the initial substrate and the one or more layers of the material commence separation from each other; and
increasing the separation space and moving the separation front along the initial substrate, wherein the initial substrate with the one or more layers of the material and the target substrate are at least partially submerged in the electrolyte solution and a potential is applied to a surface of the initial substrate that is facing the one or more layers of the material and/or to the one or more layers of the material, wherein the electrolyte diffuses between the initial substrate and the one or more layers of material, wherein the actuator is controlled to provide a progress of the separation front that is equal to or smaller than a diffusion velocity of the electrolyte.

16. The apparatus according to claim 15, wherein the actuator is connectable to the target substrate, and is configured for pulling the edge of the target substrate away from the initial substrate, wherein the apparatus preferably comprises a force sensor which is connected to the actuator and connectable to the target substrate, or
wherein the actuator is connectable to the initial substrate, and is configured for pulling the edge of the initial substrate away from the target substrate, wherein the apparatus preferably comprises a force sensor which is connected to the actuator and connectable to the initial substrate.

17. The apparatus according to claim 16, wherein the container and/or the substrate holding member is movable in a direction with a component parallel to a first interface between the initial substrate and the one or more layers of the material, preferably
wherein the actuator is configured for pulling the edge of the target substrate in a direction with a component perpendicular to the first interface, or
wherein the actuator is configured for pulling the edge of the initial substrate in a direction with a component perpendicular to the first interface.

18. The apparatus according to claim 15, 16 or 17, wherein the actuator comprises a wedge which is configured for inserting in between the initial substrate and the target substrate, preferably in a direction substantially parallel to an interface between the initial substrate and the target substrate, for pushing the target substrate with the one or more layers of the material away from the initial substrate.

19. The apparatus according to any one of the claims 15-18, wherein the apparatus further comprises an optical sensor, preferably a light detector or a camera, configured for detecting a diffusion of the electrolyte between the one or more layers of the material and the initial substrate, and wherein the optical sensor is connected to the controller for providing a measure of the diffusion of the electrolyte with respect to the separation front.

20. The apparatus according to any one of the claims 15-19, wherein the apparatus further comprises acylindrical roller which is arranged above the substrate holding member,
wherein the cylindrical roller is configured to abut on top of the target substrate, and to move along a surface of the target substrate that faces away from the initial substrate, or
wherein the cylindrical roller is configured to abut on top of the initial substrate, and to move along a surface of the initial substrate that faces away from the target substrate.
